(19) United States
(12) Patent Application Publication
(10) Pub. No.: US 2021/0224651 A1
(43) Pub. Date: Jul. 22, 2021

(54) JOINT EXTRACTION OF NAMED ENTITIES AND RELATIONS FROM TEXT USING MACHINE LEARNING MODELS

(71) Applicant: Ancestry.com Operations Inc., Lehi, UT (US)

(72) Inventors: Philip Theodore Crone, San Francisco, CA (US); Carol Myrick Anderson, Lehi, UT (US); Suraj Subraveti, Lehi, UT (US)

(73) Assignee: Ancestry.com Operations Inc., Lehi, UT (US)

(21) Appl. No.: 17/154,316

(22) Filed: Jan. 21, 2021

Related U.S. Application Data
(60) Provisional application No. 62/963,944, filed on Jan. 21, 2020.

(51) Int. Cl. G06N 3/08; G06K 9/62; G06F 40/295; G06N 3/04

(52) U.S. Cl. CPC G06N 3/08; G06N 3/04; G06F 40/295; G06K 9/6257

(57) ABSTRACT

Described herein are systems, methods, and other techniques for training a machine learning (ML) model to jointly perform named entity recognition (NER) and relation extraction (RE) on an input text. A set of hyperparameters for the ML model are set to a first set of values. The ML model is trained using a training dataset and is evaluated to produce a first result. The set of hyperparameters are modified from the first set of values to a second set of values. The ML model is trained using the training dataset and is evaluated to produce a second result. Either the first set of values or the second set of values are selected and used for the set of hyperparameters for the ML model based on a comparison between the first result and the second result.

### CROSS-REFERENCES TO RELATED APPLICATIONS

This application claims the benefit of priority to U.S. Provisional Patent Application No. 62/963,944, filed Jan. 21, 2020, entitled “METHOD FOR JOINTLY EXTRACTING NAMED ENTITIES AND RELATIONS FROM RAW TEXT USING TASK-SPECIFIC NEURAL NETWORKS,” the entire content of which is incorporated herein by reference for all purposes.

### BACKGROUND OF THE INVENTION

Information extraction is the task of extracting structured information from electronically represented sources, such as a piece of text. Two examples of information extraction tasks are named entity recognition (NER), in which named entities are located and classified in the text, and relation extraction (RE), in which semantic relationships are extracted from the text. For example, in the sentence “In 1809, author Edgar Allen Poe was born in Boston,” there are two named entities, “Edgard Allen Poe” and “Boston.” There is also a relation between these two entities, the BORN-IN relation. An NER system should determine that these spans of text correspond to named entities and should also identify the type of each entity, e.g. that “Edgar Allen Poe” is a person and that “Boston” is a location. An RE system should determine that the BORN-IN relation exists between these two entities.

These two tasks may also be performed on other types of text with more specific types of entities and relations. For example, in a marriage announcement, for the sentence “The marriage of Diane Louise Cook, granddaughter of Edwin Kohl and niece of Miss Bessie K. Kohl, of Oakwood Avenue, to Harry Eugene Holmes, took place on June seventh in Trinity Lutheran Church, Avalon”, it may be desirable to extract the entities “Diane Louise Cook,” “Edwin Kohl,” “Miss Bessie K. Kohl,” etc. It may also be desirable to extract relations such as the MARRIED-TO relation between Diane Louise Cook and Harry Eugene Holmes, the GRANDDAUGHTER-OF relation between Diane Louise Cook and Edwin Kohl, or the LOCATED-IN relation between Trinity Lutheran Church and Avalon.

Performing these tasks on raw text can be an important prerequisite for building structured databases to power search, question answering, or general knowledge base systems. For example, in the case of marriage announcements, after having extracted named entities and relations from a large number of announcements, this information may be placed in a structured database that would facilitate searching for records about Diane Louise Cook or could answer questions such as “On what date did Diane Louise Cook marry Harry Eugene Holmes?”

In some instances, the RE task is performed after the NER task sequentially in a pipeline approach by extracting the relationships between the named entities that were located during NER. Such an approach can use two independent models, with the output of the NER model serving as an input to the RE model. While the pipeline approach has some benefits, it suffers from error propagation and the inability of the RE task to inform the NER task. As such, new systems, methods, and other techniques for performing information extraction from text are needed.

### BRIEF SUMMARY OF THE INVENTION

A summary of the various embodiments of the invention is provided below as a list of examples. As used below, any reference to a series of examples is to be understood as a reference to each of those examples disjunctively (e.g., “Examples 1-4” is to be understood as “Examples 1, 2, 3, or 4”).

Example 1 is a method of training a machine learning (ML) model to jointly perform named entity recognition (NER) and relation extraction (RE) on an input text, the method comprising: setting a set of hyperparameters for the ML model to a first set of values, the set of hyperparameters including a quantity of shared layers in the ML model, a quantity of NER-specific layers in the ML model, and a quantity of RE-specific layers in the ML model, wherein the shared layers precede each of the NER-specific layers and the RE-specific layers in the ML model; training the ML model having the first set of values for the set of hyperparameters using a training dataset; evaluating the ML model having the first set of values for the set of hyperparameters using an evaluation dataset to produce a first evaluation result; modifying the set of hyperparameters from the first set of values to a second set of values; training the ML model having the second set of values for the set of hyperparameters using the training dataset; evaluating the ML model having the second set of values for the set of hyperparameters using the evaluation dataset to produce a second evaluation result; and selecting either the first set of values or the second set of values for the set of hyperparameters for the ML model based on a comparison between the first evaluation result and the second evaluation result.

Example 2 is the method of example(s) 1, wherein the ML model is a neural network.

Example 3 is the method of example(s) 1-2, wherein an output of the NER-specific layers is provided to an intermediate layer of the RE-specific layers.

Example 4 is the method of example(s) 1-3, wherein the ML model having the first set of values for the set of hyperparameters and the ML model having the second set of values for the set of hyperparameters are evaluated using an evaluation dataset.

Example 5 is the method of example(s) 1-4, wherein the shared layers include one or more shared bidirectional recurrent neural network (BiRNN) layers, and wherein the quantity of the shared layers corresponds to a quantity of the shared BiRNN layers.

Example 6 is the method of example(s) 1-5, wherein the NER-specific layers include one or more NER-specific bidirectional recurrent neural network (BiRNN) layers, and wherein the quantity of the NER-specific layers corresponds to a quantity of the NER-specific BiRNN layers.

Example 7 is the method of example(s) 1-6, wherein the RE-specific layers include one or more RE-specific bidirectional recurrent neural network (BiRNN) layers, and wherein the quantity of the RE-specific layers corresponds to a quantity of the RE-specific BiRNN layers.

Example 8 is a non-transitory computer-readable medium comprising instructions that, when executed by one or more processors, cause the one or more processors to perform operations comprising: setting a set of hyperparameters for a machine learning (ML) model to a first set of values, the set of hyperparameters including a quantity of shared layers in the ML model, a quantity of named entity recognition (NER)-specific layers in the ML model, and a quantity of relation extraction (RE)-specific layers in the ML model, wherein the shared layers precede each of the NER-specific layers and the RE-specific layers in the ML model; training the ML model having the first set of values for the set of hyperparameters using a training dataset; evaluating the ML model having the first set of values for the set of hyperparameters using an evaluation dataset to produce a first evaluation result; modifying the set of hyperparameters from the first set of values to a second set of values; training the ML model having the second set of values for the set of hyperparameters using the training dataset; evaluating the ML model having the second set of values for the set of hyperparameters using the evaluation dataset to produce a second evaluation result; and selecting either the first set of values or the second set of values for the set of hyperparameters for the ML model based on a comparison between the first evaluation result and the second evaluation result.

Example 9 is the non-transitory computer-readable medium of example(s) 8, wherein the ML model is a neural network.

Example 10 is the non-transitory computer-readable medium of example(s) 8, wherein an output of the NER-specific layers is provided to an intermediate layer of the RE-specific layers.

Example 11 is the non-transitory computer-readable medium of example(s) 8, wherein the ML model having the first set of values for the set of hyperparameters and the ML model having the second set of values for the set of hyperparameters are evaluated using an evaluation dataset.

Example 12 is the non-transitory computer-readable medium of example(s) 8, wherein the shared layers include one or more shared bidirectional recurrent neural network (BiRNN) layers, and wherein the quantity of the shared layers corresponds to a quantity of the shared BiRNN layers.

Example 13 is the non-transitory computer-readable medium of example(s) 8, wherein the NER-specific layers include one or more NER-specific bidirectional recurrent neural network (BiRNN) layers, and wherein the quantity of the NER-specific layers corresponds to a quantity of the NER-specific BiRNN layers.

Example 14 is the non-transitory computer-readable medium of example(s) 8, wherein the RE-specific layers include one or more RE-specific bidirectional recurrent neural network (BiRNN) layers, and wherein the quantity of the RE-specific layers corresponds to a quantity of the RE-specific BiRNN layers.

Example 15 is a system for training a machine learning (ML) model to jointly perform named entity recognition (NER) and relation extraction (RE) on an input text, the system comprising: one or more processors; and a computer-readable medium comprising instructions that, when executed by the one or more processors, cause the one or more processors to perform operations comprising: setting a set of hyperparameters for the ML model to a first set of values, the set of hyperparameters including a quantity of shared layers in the ML model, a quantity of NER-specific layers in the ML model, and a quantity of RE-specific layers in the ML model, wherein the shared layers precede each of the NER-specific layers and the RE-specific layers in the ML model; training the ML model having the first set of values for the set of hyperparameters using a training dataset; evaluating the ML model having the first set of values for the set of hyperparameters using an evaluation dataset to produce a first evaluation result; modifying the set of hyperparameters from the first set of values to a second set of values; training the ML model having the second set of values for the set of hyperparameters using the training dataset; evaluating the ML model having the second set of values for the set of hyperparameters using the evaluation dataset to produce a second evaluation result; and selecting either the first set of values or the second set of values for the set of hyperparameters for the ML model based on a comparison between the first evaluation result and the second evaluation result.

Example 16 is the system of example(s) 15, wherein the ML model is a neural network.

Example 17 is the system of example(s) 15, wherein an output of the NER-specific layers is provided to an intermediate layer of the RE-specific layers.

Example 18 is the system of example(s) 15, wherein the ML model having the first set of values for the set of hyperparameters and the ML model having the second set of values for the set of hyperparameters are evaluated using an evaluation dataset.

Example 19 is the system of example(s) 15, wherein the shared layers include one or more shared bidirectional recurrent neural network (BiRNN) layers, and wherein the quantity of the shared layers corresponds to a quantity of the shared BiRNN layers.

Example 20 is the system of example(s) 15, wherein the NER-specific layers include one or more NER-specific bidirectional recurrent neural network (BiRNN) layers, and wherein the quantity of the NER-specific layers corresponds to a quantity of the NER-specific BiRNN layers.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and various ways in which it may be practiced.

FIG. 1 illustrates an example of performing named entity recognition (NER) and relation extraction (RE) on an input text.

FIG. 2 illustrates an example system for implementing a joint model to generate entity predictions and relationship predictions for an input text.

FIG. 3 illustrates an example architecture of a joint model for performing NER and RE on an input text.

FIG. 4 illustrates an example architecture of a joint model for performing NER and RE on an input text.

FIG. 5 illustrates a table showing optimal hyperparameters.

FIG. 6 illustrates a table showing results for the proposed model along with results from other recent work.

FIG. 7 illustrates a table showing results using the CoNLL04 dataset while varying the types of contextual and non-contextual embeddings.

FIG. 8 illustrates a table showing results using the CoNLL04 dataset and removing task-specific BiRNN layers while maintaining the same number of total parameters

FIG. 9 illustrates plots showing results using the CoNLL04 dataset and varying the number of shared and task-specific BiRNN layers while leaving other hyperparameters unmodified.

FIGS. 10A-10D illustrate example steps for training a joint model while identifying a set of optimized hyperparameters.

FIG. 11 illustrates a method of training a machine learning (ML) model to jointly perform NER and RE on an input text.

FIG. 12 illustrates a method of training an ML model to jointly perform NER and RE on an input text.

FIG. 13 illustrates an example computer system comprising various hardware elements.

### DETAILED DESCRIPTION OF THE INVENTION

Named entity recognition (NER) and relation extraction (RE) are two important information extraction tasks that have applications in search, question answering, and knowledge base construction. NER consists in the identification of spans of text corresponding to named entities and the classification of each span's entity type. RE consists in the identification of all triples (eᵢ, eⱼ, r), where eᵢ and eⱼ are named entities and r is a relation that holds between eᵢ and eⱼ according to the text.

One option for solving these two problems is a pipeline approach using two independent models, with the output of the NER model serving as an input to the RE model.

However, multi-task learning (MTL) approaches can be successfully applied to solve these two problems using a single model. In the context of joint NER and RE, the MTL paradigm most commonly used is that of hard parameter sharing, which makes use of deep neural architectures in which inputs first pass through one or more shared layers. The model architecture then branches with the hidden representations produced by the shared layers feeding into task-specific layers, which ultimately produce outputs for each task.

The MTL approach to jointly solving NER and RE offers several advantages over the pipeline approach. First, the pipeline approach is more susceptible to error propagation where prediction errors from the NER model enter the RE model as inputs that the latter model cannot correct. Second, the pipeline approach only allows solutions to the NER task to inform the RE task, but not vice versa. In contrast, the joint approach also allows for solutions to the RE task to inform the NER task.

Some approaches include joint NER and RE models that share the vast majority of parameters between the NER and RE tasks, but include separate scoring and/or output layers to produce separate outputs for each task. For example, some approaches propose models in which token representations first pass through one or more shared bidirectional long short-term memory (BiLSTM) layers. To solve the NER task, tokens are then tagged with BIO or BILOU tags using either a softmax or conditional random field (CRF) layer operating on the output of these BiLSTM layers. To solve the RE task, either an attention or a sigmoid layer is used. Some approaches introduce greater task-specificity for RE by adding a type of tree-structured BiLSTM layer, stacked on top of a shared BiLSTM layer, to solve the RE task. Some approaches add an RE-specific BiLSTM layer stacked on top of shared BiLSTM and CRF layers.

An alternative to solving the NER task via BIO/BILOU tagging is the span-based approach, where spans of the input text are directly labeled as to whether they correspond to any entity and, if so, their entity types. Joint methods to NER and RE that employ the span-based approach for the NER task generally share most model parameters between the two tasks, but feature task-specific scoring and/or output layers. Some approaches adopt a span-based approach in which token representations are first passed through a BiLSTM layer. The output from the BiLSTM is used to construct representations of candidate entity spans, which are then scored for both the NER and RE tasks via feed forward layers. Some approaches extend this method by constructing coreference and relation graphs between entities to propagate information between entities connected in these graphs.

Some approaches eschew the MTL paradigm by treating the NER and RE tasks as if they were a single task. For example, some approaches treat the two tasks as a table-filling problem where each cell in the table corresponds to a pair of tokens (tᵢ, tⱼ) in the input text. The cells along the diagonal of the table (tᵢ, tⱼ) are labeled with the BILOU tag for tᵢ, off-diagonal cells are labeled with relation labels, and a bidirectional recurrent neural network (BiRNN) is trained to fill the cells of the table. Some approaches introduce a BILOU tagging scheme that incorporates relation information into the tags, allowing them to treat both tasks as if they were a single NER task. Some approaches treat both tasks as a form of multi-turn question answering in which the input text is queried with question templates first to detect entities and then, given the detected entities, to detect any relations between these entities. Some approaches produce answers by tagging the input text with BILOU tags to identify the span corresponding to the answers. Some approaches involve fine-tuning of a bidirectional encoder representations from transformers (BERT) model to generate hidden representations that are shared between the NER and RE tasks. These hidden representations are then passed through a small sequence of task-specific layers to produce final outputs.

Some embodiments of the present disclosure relate to a novel deep learning architecture and model to jointly solve NER and RE. In some embodiments, the model produces predictions for each of the NER and RE tasks by: (1) computing representations of the input text; (2) passing these representations through a series of shared neural network layers; and (3) passing the output from the shared neural network layers through a series of task-specific neural network layers for each task. Various embodiments may be agnostic with respect to the number of shared and task-specific layers in the model. Each of these numbers can each be treated as a “hyperparameter,” i.e. a part of the model architecture that can be adjusted for different datasets depending on the importance of shared vs. task-specific information relevant for solving the problem of joint NER and RE on the specific dataset.

The proposed model differs from previous proposals in several ways, including but not limited to: (1) deeper task-specificity than previous work via the use of additional task-specific bidirectional recurrent neural networks (BiRNNs) for both tasks; (2) because the relatedness between the NER and RE tasks is not constant across all textual domains, the number of shared and task-specific layers are taken to be an explicit hyperparameter of the model that can be tuned separately for different datasets; and (3) utilization of BERT purely as a feature extractor without any fine tuning, which allows the described architecture to have many fewer trainable parameters than other approaches and, in turn, allows for greater experimentation with the number of shared and task-specific layers that operate on the BERT-derived features.

As described herein, the proposed architecture was evaluated on two datasets: the Adverse Drug Events (ADE) dataset and the CoNLL04 dataset. In the case of ADE, the proposed architecture outperforms the current state-of-the-art (SOTA) results on the NER task and achieves near SOTA results on the RE task. In the case of CoNLL04, SOTA performance was achieved on both tasks. For both datasets, SOTA results are achieved when averaging performance across both tasks.

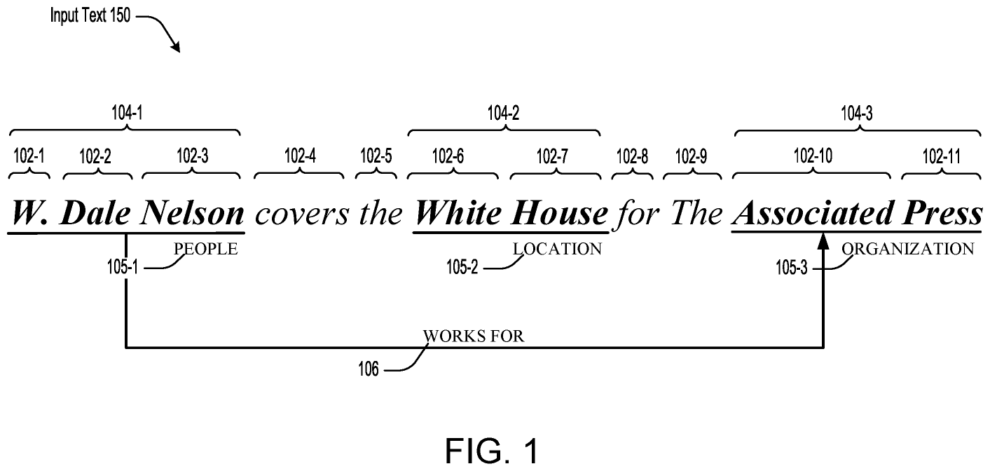

FIG. 1 illustrates an example of performing NER and RE on an input text 150. In the illustrated example, input text 150 includes the sentence “W. Dale Nelson covers the White House for The Associated Press”. By processing input text 150 using NER and RE, W. Dale Nelson, White House, and Associated Press are determined to be named entities 104 and their corresponding entity types 105 are determined to be People, Location, and Organization, respectively. Additionally, processing of input text 150 can determine a relationship 106 of Works-For between W. Dale Nelson and Associated Press. The example in FIG. 1 demonstrates how the MTL approach to jointly solving NER and RE allows the RE task to inform the NER task. For example, learning that there is a Works-For relation between W. Dale Nelson and Associated Press can be useful for determining the types of these entities.

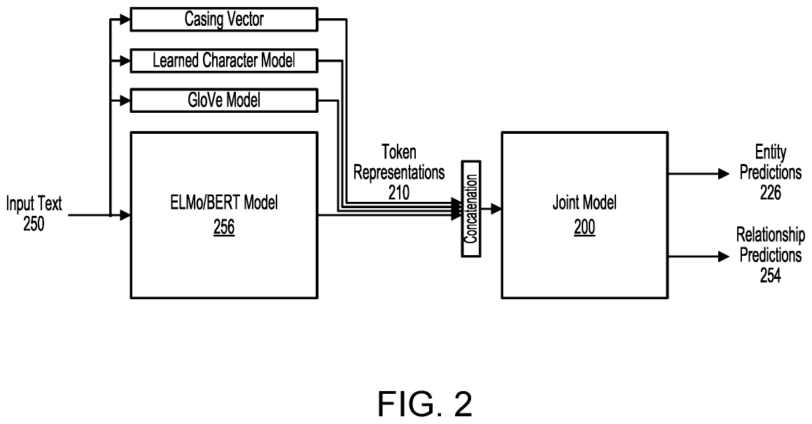

FIG. 2 illustrates an example system for implementing a joint model 200 to generate entity predictions 226 and relationship predictions 254 for an input text 250. Joint model 200 may jointly and concurrently perform the NER and RE tasks on an input. In the illustrated example, joint model 200 is provided with token representations 210 as its input. Token representations 210 may be generated by an ELMo/BERT model 256 based on input text 250. ELMo/BERT model 256 may be pre-trained to provide a vector representation for each token of input text 250, the vector representations collectively comprising token representations 210. Joint model 200 may then be trained with token representations 210 using manually-prepared training data in a supervised manner.

In some embodiments (and as shown in the illustrated example), input text 250 is further passed through a pre-trained GloVe model, which outputs non-contextual embeddings for each word of input text 250, a character level language model, which may be trained along with the other trainable parts of the architecture, and which outputs a learned character-level embedding for each word of input text 250, and a casing vector, which is a one-hot encoded representation that conveys the geometry of the words in input text 250 (e.g., uppercase, lowercase, mixed case, alphanumeric, special characters, etc.). In some embodiments, one or more of these outputs, along with the output of the pre-trained ELMo/BERT model 256 that outputs contextual embeddings, may collectively form token representations 210. In some instances, the outputs may be concatenated to form full representations.

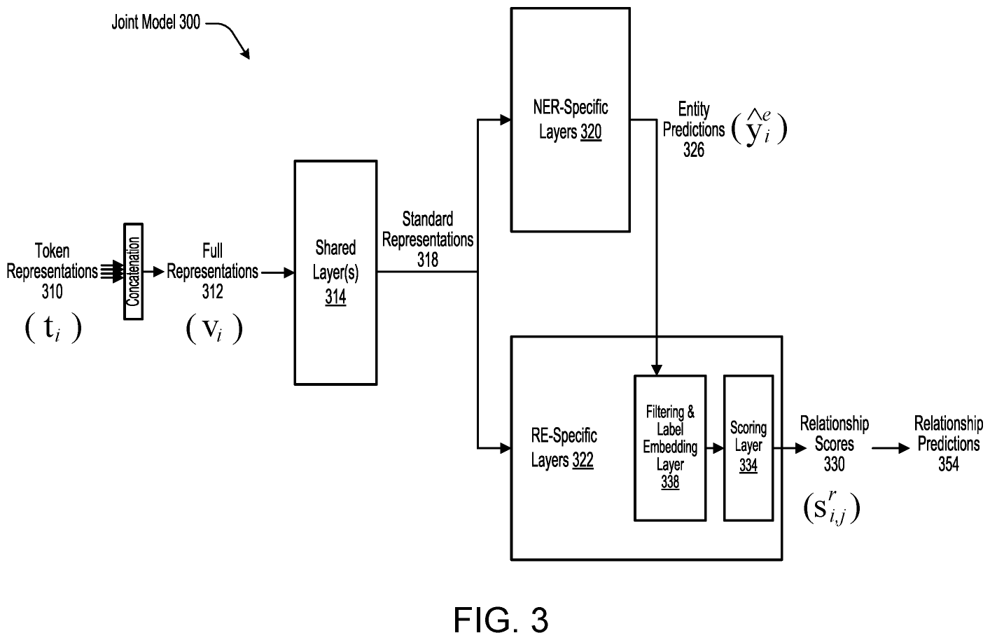

FIG. 3 illustrates an example architecture of a joint model 300 for performing NER and RE on an input text. Various components in FIG. 3 may correspond to similarly labelled components in previous and/or subsequent figures. For example, joint model 300 may correspond to joint model 200, token representations 310 may correspond to token representations 210, and so on. The superscript e is used herein for NER-specific variables and layers and the superscript r is used for RE-specific variables and layers.

In some embodiments, the NER task is treated as a sequence labeling problem using BIO labels. Token representations 310 are concatenated to form full representations 312 and are passed through a series of shared layers 314, which may include one or more shared BiRNN layers. The output of shared layers 314, referred to as standard representations 318, is passed to a sequence of task-specific layers for each of the NER and RE tasks, referred to as NER-specific layers 320 and RE-specific layers 322. The output of NER-specific layers 320 is entity predictions 326, which include a predicted entity for each token of the input text. Entity predictions 326 are passed to a filtering and label embedding layer 338 of RE-specific layers 322. The output of filtering and label embedding layer 338 is passed to scoring layer 334, which generates relationship scores 330. As such, the output of NER-specific layers 320 is provided to an intermediate layer of RE-specific layers 322. Based on relationship scores 330, relationship predictions 354 between the entities can be determined.

With respect to token representations 310 and full representations 312, in some embodiments, contextual WordPiece embeddings are obtained using the pre-trained BERTLARGE model with whole word masking. In particular, the representations from the final four BERT layers may be used, which are combined for each WordPiece token via a weighted averaging layer. This may constitute a “feature-based approach” to using a pre-trained BERT model, which greatly reduces the number of trainable model parameters, allowing a greater number of configurations regarding the number of shared and task-specific parameters to be experimented with.

Each WordPiece token tᵢ's weighted BERT embedding tᵢ^{bert} is concatenated to a set of embeddings associated with the original word that token tᵢ was derived from. This set may include pre-trained GloVe embeddings tᵢ^{glove}, a character-level word embedding tᵢ^{char} learned via a single BiRNN layer, and a one-hot encoded casing vector tᵢ^{casing}. For example, WordPiece tokenization may split the word encyclopedia into five tokens: en, 12cy, 12c, 12lop, and 12edia. Each token may receive a separate BERT-based embedding, but all may share the same GloVe embedding, learned character-based embedding, and one-hot encoded casing embedding of the original word encyclopedia. For tᵢ^{glove}, 100-dimensional GloVe embeddings trained on English Wikipedia and Gigaword can be used.

The full representation of tᵢ is given by vᵢ, which may, in some embodiments, be expressed as follows:

vᵢ=tᵢ^{bert} ∘tᵢ^{glove} ∘tᵢ^{char} ∘tᵢ^{casing}

where ∘ denotes concatenation. For a document with n tokens, the sequence v_{1:n} is fed as input to shared layers 314.

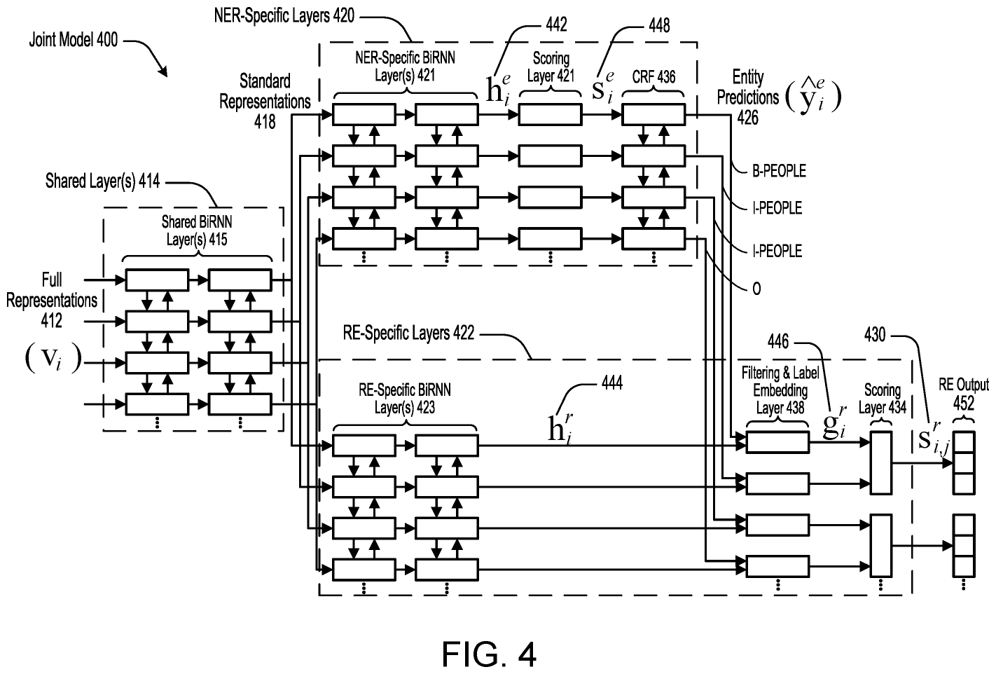

FIG. 4 illustrates an example architecture of a joint model 400 for performing NER and

RE on an input text. Various components in FIG. 4 may correspond to similarly labelled components in previous and/or subsequent figures. For example, joint model 400 may correspond to joint models 100 and 200, shared layer(s) 414 may correspond to shared layer(s) 314, and so on.

In the illustrated example, shared layer(s) 414 includes one or more shared BiRNN layer(s) 415. These BiRNN layers are stacked so that the output sequence from the ith shared BiRNN layer is the input sequence to the i+1 shared BiRNN layer. The final layer of shared BiRNN layer(s) 415 is followed by one or more NER-specific BiRNN layer(s) 421 of NER-specific layers 420 and one or more RE-specific BiRNN layer(s) 423 of RE-specific layers 422. NER-specific BiRNN layer(s) 421 and RE-specific BiRNN layer(s) 423 are stacked in a similar manner as shared BiRNN layer(s) 415. The number (or quantity) of layers in each of shared BiRNN layer(s) 415, NER-specific BiRNN layer(s) 421, and RE-specific BiRNN layer(s) 423 are considered to be hyperparameters of joint model 400.

Let hᵢ^{e} denote an NER-specific hidden representation 442 corresponding to the ith element of the output sequence from the final BiRNN layer in the stack of shared and NER-specific BiRNN layers 421. An entity score 448 for token tᵢ, sᵢ^{e}, is obtained by passing he through a series of two feed forward layers:

sᵢ^{e}=FFNN^{(e2)}((FFNN^{(e1)}(hᵢ^{e})))

The activation function of FFNN^{(e1)} and its output size are treated as hyperparameters. FFNN^{(e2)} uses linear activation and its output size is |ε|, where ε is the set of possible BIO tags. The sequence of entity scores 448 (or NER scores) for all tokens, s_{1:n}^{e}, are then passed to a linear-chain CRF layer 436 to produce a sequence of entity predictions 426, ŷ_{1:n}^{e}, which may alternatively be referred to as BIO tag predictions. During inference, Viterbi decoding is used to determine the most likely sequence ŷ_{1:n}^{e}.

In addition to being fed to a series of NER-specific layers, the output sequence from the final shared BiRNN layer is fed to a series of zero or more RE-specific BiRNN layers 423. Let hⁱᵣ denote an RE-specific hidden representation 444 corresponding to the ith output from the final BiRNN layer in the stack of shared and RE-specific BiRNN layers 423. Relations between entities eᵢ and eⱼ are predicted using learned representations from the final tokens of the spans corresponding to eᵢ and eⱼ. To this end, the sequence h_{1:n}^{r} is filtered to include only elements hᵢ^{r} such that token tᵢ is the final token in an entity span. Each hidden representation hᵢ^{r} is concatenated to a learned NER label embedding for tᵢ, lᵢ^{e}:

gᵢ^{r}=hᵢ^{r} ∘lᵢ^{e}

where gᵢ^{r} is alternatively referred to as entity label embeddings 446. For the purposes of filtering the sequence h_{l:n}^{r} and generating label embeddings l_{l:n}^{e}, ground truth NER labels are used during training, and predicted labels are used during inference.

Next, relationship scores 430 (or RE scores) are computed for every pair (gᵢ^{r}, gⱼ^{r}). If R is the set of possible relations, the DISTMULT score is calculated for every relation rₖ ∈ R and every pair (gᵢ^{r}, gⱼ^{r}) as follows:

DISTMULT^{r}^{ₖ}(gᵢ^{r}, gⱼ^{r})=(gᵢ^{r})^{T}M^{r}^{ₖ}gⱼ^{t}

where M^{r}^{ₖ} is a diagonal matrix such that M^{r}^{ₖ} ∈ R^{p×p}, where p is the dimensionality of gⱼ^{r}. Each entity label embedding gⱼ^{r} is also passed through two feed forward layers in order to obtain head and tail representations for each entity:

fᵢ^{r,head}=FFNN^{(r1,head)}(gᵢ^{r})

fᵢ^{r,tail}=FFNN^{(r1,tail)}(gᵢ^{r})

The same output size and activation function is used for FFNN^{(r1,head)} and FFNN^{(r1,tail)}. As in the case of FFNN^{(e1)}, these values are treated as hyperparameters.

Let DISTMULT_{i,j}^{r} denote the concatenation of DISTMULT^{r}^{ₖ} (gᵢ^{r}, gⱼ^{r}) for all rₖ ∈ R and let cos_{i,j} denote the cosine distance between fᵢ^{r,head} and fᵢ^{r,tail}. Relationship score 430 or RE score s_{i,j}^{r,} are obtained for (tᵢ, tⱼ) via a feed forward layer:

s_{i,j}^{r}=FFNN^{(r2)}(fᵢ^{r,head} ∘fⱼ^{r,tail} ∘cos_{i,j} ∘DISTMULT_{i,j}^{r})

where FFNN^{(r2)} uses linear activation and its output size is |R|. Final relation predictions for a pair of tokens (tᵢ, tⱼ), ŷ_{i,j}^{r} are obtained by passing s_{i,j}^{r,} through an elementwise sigmoid layer. A relation is predicted for all outputs from this sigmoid layer exceeding θ^{r}, which is treated as a hyperparameter. The predicted relationships form RE output 452.

During training, character embeddings, label embeddings, and weights for the BERT weighted averaging layer, all BiRNN weights, all feed forward networks, and M^{r}^{ₖ} for all rₖ ∈ R are trained in a supervised manner. As mentioned above, BIO tags are used as labels for the NER task. For every relation rₖ ∈ R and for every pair of tokens (tᵢ, tⱼ) such that tᵢ is the final token of entity eᵢ and tⱼ is the final token of entity eⱼ, the RE label y_{i,j}^{r}^{ₖ}=1 if eᵢ, eⱼ, rₖ is a true relation, and y_{i,j}^{r}^{ₖ}=0 otherwise.

For the NER output layer, the negative log likelihood loss is computed, while for the RE output layer, the binary cross-entropy loss is computed. If L_{NER} and L_{RE} denote the losses for the NER and RE outputs, respectively, then the total model loss is given by=L=L_{NER}+λ^{r}L_{NER}. The weight λ^{r} is treated as a hyperparameter and allows for tuning the relative importance of the NER and RE tasks during training. In some implementations, final training for both datasets used a value of 5 for λ^{r}.

In the described experiments, a mini-batch size of 32 was used. For the ADE dataset, the training used the Adam optimizer with a learning rate of 5×10⁻⁴. For the CoNLL04 dataset, the training used the Nesterov Adam optimizer using a learning rate of 1×10⁻³. Dropout was applied during training before each BiRNN layer, other than the character BiRNN layer, and before both the NER and RE scoring layers. A dropout probability of 0.5 was used for all dropout layers, with the exception of the pre-NER scoring dropout in which case a dropout probability of 0.25 was used.

The proposed architecture was evaluated using the following two datasets: the ADE dataset and the CoNLL04 dataset. The ADE dataset consists of 4,272 sentences describing adverse effects from the use of particular drugs. The text is annotated using two entity types (Adverse-Effect and Drug) and a single relation type (Adverse-Effect). 120 entities were removed whose spans overlap with those of other entities. The entity with the longer span was preversed and any relations involving a removed entity were removed. There are no official training, development, and test splits for this dataset, leading previous researchers to use cross-validation for evaluation. 1.0% of the data was split out to use as a development set. Final results are obtained via 10-fold cross-validation using the remaining 90% of the data and the hyperparameters obtained from tuning on the development set. Macro-averaged performance metrics are reported averaged across each of the 10 folds. For each fold, the metrics obtained following the training epoch that achieved the highest average of the macro-averaged NER Fl scores and macro-averaged RE Fl scores were used.

The CoNLL04 dataset consists of 1,441 sentences from news articles annotated with four entity types (Location, Organization, People, and Other) and five relation types (Works-For, Kill, Organization-Based-In, Lives-In, and Located-In). The three-way split was used, which contains 910 training, 243 development, and 288 test sentences. All hyperparameters are tuned against the development set. Final results are obtained by averaging results from five trials with random weight initializations trained on the combined training and development sets and evaluated on the test set. As previous work using the CoNLL04 dataset has reported both macro- and micro-averages, both sets of metrics are reported. In each case, metrics obtained following the training epoch that achieved the highest average of macro-/micro-avenged NER Fl scores and macro-/micro-averaged RE Fl scores were used.

In evaluating NER performance on these datasets, a predicted entity is only considered a true positive if both the entity's span and span type are correctly predicted. In evaluating RE performance, a strict evaluation method was adopted wherein a predicted relation is only considered correct if the spans corresponding to the two arguments of this relation and the entity types of these spans are also predicted correctly.

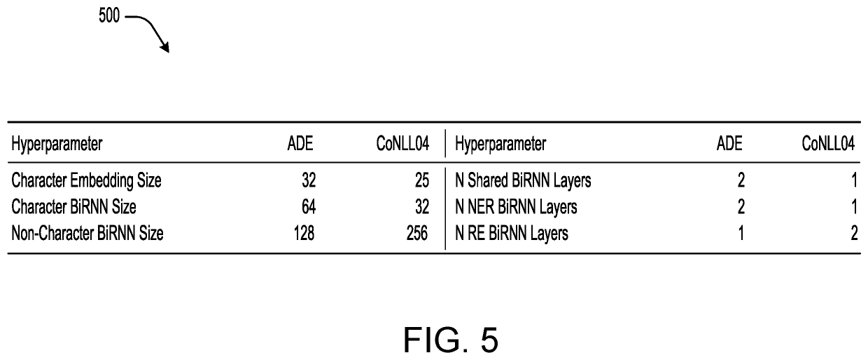

FIG. 5 illustrates a table 500 showing optimal hyperparameters in cases where the values differed for each dataset. In many cases, optimal hyperparameters were the same for both datasets. GRUs were used for all BiRNN layers. A dimensionality of 25 was used for label embeddings. For FFNN^{(e1)}, an output size of 64 was used with tan h activation. For FFNN^{(r1,head/tail)}, an output size of 128 was used with ReLU activation. For experiments with the CoNLL04 dataset, no benefit was found for training separating head and tail feedforward networks, so FFNN^{(r1, head)}=FFNN^{(r1,tail)}. A size of 32 was used for the character-level BiGRU layer.

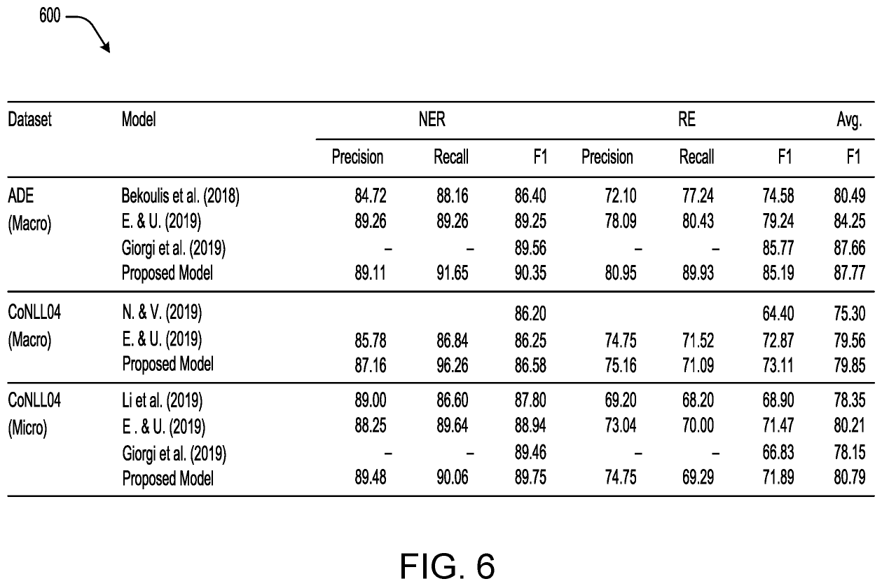

FIG. 6 illustrates a table 600 showing results for the proposed model (the “joint model”) along with results from other recent work. In addition to precision, recall, and Fl scores for both tasks, the average of the Fl scores are shown across both tasks. The previous state-of-the-art (SOTA) results on the ADE and CoNLL 2004 datasets have been achieved by Giorgi et al. (2019) and Eberts and Ulges (2019), respectively. On the ADE dataset, the SOTA results were exceeded for the NER task and results competitive with the SOFA were achieved on the RE task. On the CoNLL04 dataset, SOFA results were achieved on both tasks using both macro- and micro-averaged scores. The results of the prosposed model on both datasets are SOTA when considering the average Fl score across both tasks. Relative to the previous SOTA results, the largest absolute increase in Fl score that was observed on a single task is an increase of 0.79 on the macro-average NER Fl score on the ADE dataset.

While the improvements relative to the previous SOTA results are relatively small, they are noteworthy for at least two additional reasons. First, SOTA results were achieved on both the ADE and CoNLL04 datasets, whereas Giorgi et al. (2019) and Eberts and Ulges (2019) only show SOTA results on one of these two datasets. Second, the results of the prospoed model were achieved using an order of magnitude fewer trainable parameters than do the previous SOTA approaches. Both Giorgi et al. (2019) and Eberts and Ulges (2019) rely on fine-tuning a BERT model with over 100 million trainable parameters. In contrast, the proposed architecture with the optimal hyperparameters for the ADE dataset included approximately 2.4 million trainable parameters, while the architecture with the optimal hyperparameters for the CoNLL04 dataset included approximately 5.9 million trainable parameters. More generally, the results of the proposed model show that using BERT as a feature extractor in conjunction with deeper layers operating on these extracted features can achieve similar results to full fine-tuning of BERT with shallower layers operating on the output of the fine-tuned BERT model.

It is also noted that the optimal number of shared, NER-specific, and RE-specific BiRNN layers used for final training, as determined by tuning on each dataset's development set, differed between the two datasets. In the case of the ADE dataset, optimal performance was achieved using 2 shared, 2 NER-specific, and 1 RE-specific BiRNN layers. In the case of the CoNLL04 dataset, optimal performance was achieved using 1 shared, 1 NER-specific, and 2 RE-specific BiRNN layers. The fact that the optimal number of shared and task-specific layers differed between the two datasets demonstrates the value of taking the number of shared and task-specific layers to be a hyperparameter of the proposed model architecture.

In order to further understand how aspects of the proposed architecture contributed to the results, three additional sets of experiments were conducted using the CoNLL04 dataset. The first was an ablation study using different types of embeddings for obtaining the initial token representations used in the model, while the second two vary the number of shared and task-specific layers.

To understand the effect of using BERT-derived contextual token embeddings and non-contextual GloVe embeddings, an ablation study was conducted in which the type of contextual token embeddings used were modified and/or the non-contextual GloVe embeddings from token representations were excluded. In varying the type of contextual embeddings used, either the BERT embeddings were replaced with embeddings from the pre-trained ELMo 5.5B model or contextual embeddings were removed altogether. All other model hyperparameters were the same as those used to obtain the results reported in FIGS. 5 and 6. For each configuration of token embeddings, three trials were run with random weight initializations. Average performance across these three trials are reported, except in the case of the baseline configuration.

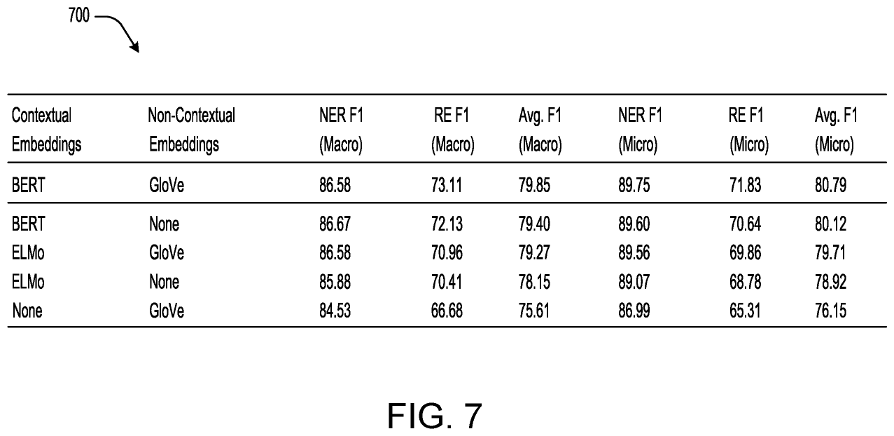

FIG. 7 illustrates a table 700 showing results using the CoNLL04 dataset while varying the types of contextual and non-contextual embeddings. The inclusion of contextual token embeddings is clearly beneficial to the model performance, as all configurations including either BERT or ELMo embeddings outperform the model that includes only non-contextual GloVe embeddings. Nonetheless, the inclusion of GloVe embeddings does improve performance when contextual embeddings are used. When using ELMo, the inclusion of GloVe improves performance across all tasks. When using BERT, the inclusion of GloVe improves performance on the RE task with little to no effect on the NER task. A modest improvement on micro-averaged NER Fl score and a small decrease in the macro-averaged NER Fl score were observed.

These experiments indicate that the use of BERT-derived token embeddings can be beneficial for achieving SOTA results. Still, the model's performance is impressive even without the use of BERT-derived embeddings. When using a combination of ELMo and GloVe embeddings, the model's performance is competitive with the model proposed by Eberts and Ulges (2019) and actually exceeds the performance of Giorgi et al.'s (2019) model on the CoNLL04 dataset.

One characteristic of the proposed model is the inclusion of shared and task-specific BiRNN layers, the number of which is treated as a hyperparameter to be tuned for individual datasets. In order to better understand the impact of varying the number of shared and task specific pararmeters, two sets of additional experiments were conducted using the CoNLL04 dataset. In the both sets of experiments, the model was trained and evaluated in the same manner described above and used the same hyperparameters to obtain the results shown in FIG. 6, except where noted.

In the first set of experiments. either (i) zero NER-specific BiRNN layers, (ii) zero RE-specific BiRNN layers, or (iii) zero task-specific BiRNN layers of any kind were used. In order to keep the total number of model parameters consistent with the number of parameters in the baseline model, the number of shared BiRNN layers were increased. Three trials were ran for each of the new hyperparameter configurations and results are reported by averaging across these three trials.

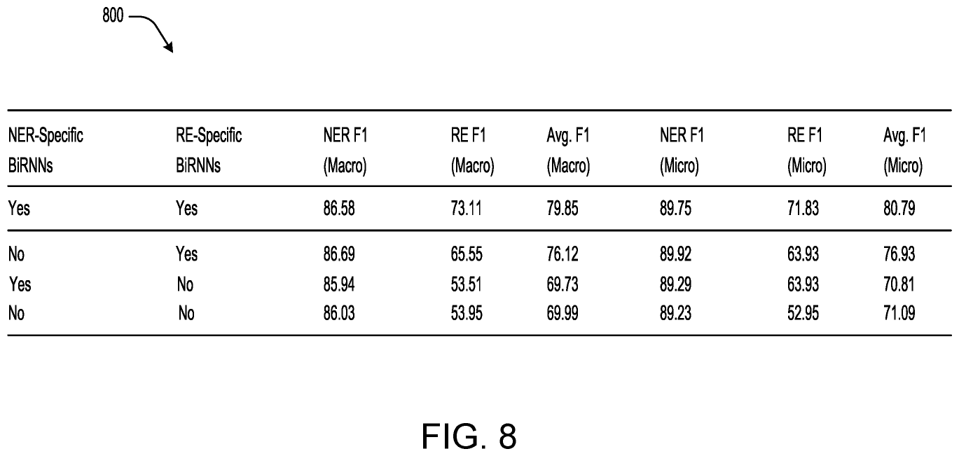

FIG. 8 illustrates a table 800 showing results using the CoNLL04 dataset and removing task-specific BiRNN layers while maintaining the same number of total parameters. The overall performance of the model, as measured by the average of NER and RE Fl scores, is negatively impacted by removing any kind of task-specific BiRNN layer and replacing it with a shared BiRNN layer. However. the performance on the NER task is relatively unchanged by varying the number of task-specific layers in these experiments, while the performance on the RE task is significantly impacted. This is particularly true when RE-specific BiRNN layers are excluded. Because the removal of task-specific BiRNN layers was acompanied by an increase in the number of shared BiRNN layers in these experiments, these results are compatible with multiple explanations. Performance on the RE task may simply benefit from the inclusion of task-specific layers, but it is also possible that the performance on the RE task degrades when additional shared layers are included in the model architecture.

To explore these two explanations, a second set of experiments were conducted. The number of shared and task-specific BiRNN layers were again varied, but only a single layer type was modified at a time, i.e. only the number of shared BiRNN layers, only the number of NFR-specific BiRNN layers, or only the number of RE-specific BiRNN layers were modified. Between one and three shared BiRNN layers and between zero and three task-specific BiRNN layers were experimented for both tasks. Three trials were ran for each of the new hyperparameter configurations and results are reported by averaging across these three trials. For hyperparameter settings matching the optimal hyperparameters, the original results shown in FIG. 6 are reported.

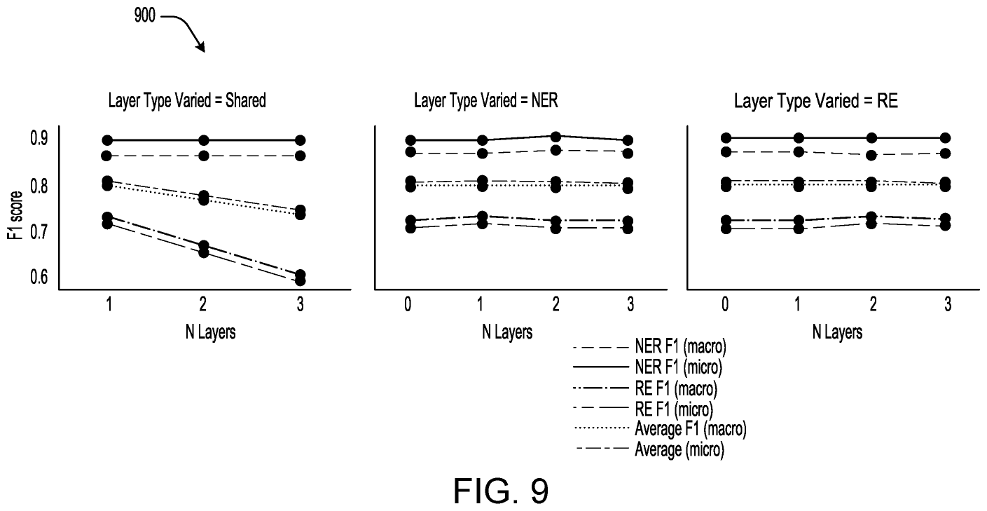

FIG. 9 illustrates plots 900 showing results using the CoNLL04 dataset and varying the number of shared and task-specific BiRNN layers while leaving other hyperparameters unmodified. There is relatively little impact on the performance of the model on either task when modifying the number of NER-specific or RE-specific BiRNN layers. There is little impact on the performance of the model on the NER task when varying the number of shared layers. However, increasing the number of shared BiRNN layers has a large negative impact on the RE performance. This suggests that the results shown in FIG. 8 are primarily driven by the increase in shared BiRNN layers that accompanied the removal of task-specific layers. rather than by the removal of those layers.

Taken together, these two sets of experiments show that performance on the NER task with the proposed architecture is robust to different choices of the number of shared and task-specific layers. Performance on the RE task is more sensitive to these choices, at least with respect to the choice regarding the number of shared BiRNN layers. This result is taken to be in part a consequence of the fact that the NER task is easier than the RE task, thereby making a wider range of architectures capable of solving the NER task. It is unclear why performance of the RE task appears only to be sensitive to the number of shared BiRNN layers, rather than the number of RE-specific BiRNN layers.

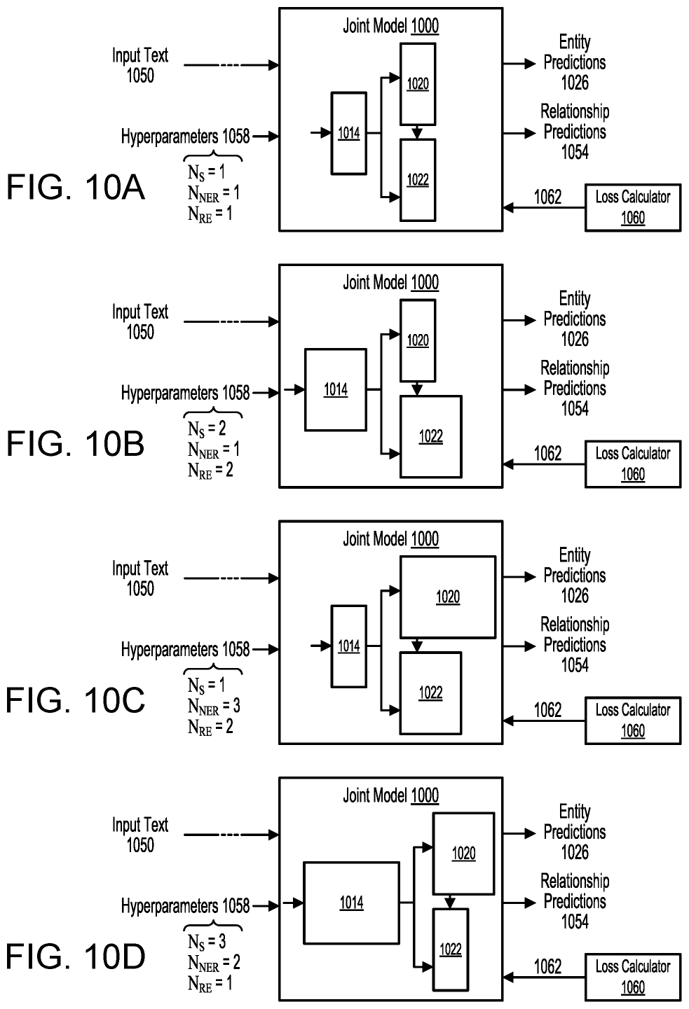

FIGS. 10A-10D illustrate example steps for training a joint model 1000 while identifying a set of optimized hyperparameters. Various components in FIGS. 10A-10D may correspond to similarly labelled components in previous and/or subsequent figures. In the illustrated example, a set of hyperparameters 1058 associated with joint model 1000 include a quantity N_{S} of shared layers 1014 of joint model 1000, a quantity N_{NER} of NER-specific layers 1020 of joint model 1000, and a quantity N_{RE} of RE-specific layers 1022 of joint model 1000.

In reference to FIG. 10A, hyperparameters 1058 are initially set to the following set of values: N_{S}=1, N_{NER}=1, and N_{RE}=1. Joint model 1000 is then trained by providing input text 1050 from a training dataset to joint model 1000, generating entity predictions 1026 and relationship predictions 1054 using joint model 1000 based on input text 1050, calculating a loss 1062 using a loss calculcator 1060 based on a comparison between entity predictions 1026, relationship predictions 1054, and corresponding ground-truth data (e.g., manually-prepared training data), and modifying weights associated with joint model 1000 based on loss 1062. This process may be repeated for the entire training dataset and/or over multiple epochs until arriving at a set of final weights for joint model 1000.

In reference to FIG. 10B, hyperparameters 1058 are modified from the set of values shown in FIG. 10A to the following set of values: N_{S}=2, N_{NER}=1, and N_{RE}=2. Joint model 1000 is then trained in the same manner as described in reference to FIG. 10A. In some instances, the loss achieved with the hyperparameters used in FIG. 10B may be compared to the loss achieved with the hyperparameters used in FIG. 10A to determine which set of values may be selected and used for the hyperparameters of joint model 1000 after completion of the training process. Alternatively or additionally, in some embodiments, each of joint models 1000 trained in FIGS. 10A and 10B may be evaluated using an evaluation dataset to determine which set of values may be selected and used for the hyperparameters of joint model 1000.

In reference to FIG. 10C, hyperparameters 1058 are modified from the set of values shown in FIG. 10B to the following set of values: N_{S}=1, N_{NER}=3, and N_{RE}=2. Joint model 1000 is then trained in the same manner as described in reference to FIG. 10A. In some instances, the loss achieved with the hyperparameters used in FIG. 10C may be compared to the losses achieved with the hyperparameters used in FIGS. 10A and 10B to determine which set of values may be selected and used for the hyperparameters of joint model 1000 after completion of the training process. Alternatively or additionally, in some embodiments, each of joint models 1000 trained in FIGS. 10A-10C may be evaluated using an evaluation dataset to determine which set of values may be selected and used for the hyperparameters of joint model 1000.

In reference to FIG. 10D, hyperparameters 1058 are modified from the set of values shown in FIG. 10C to the following set of values: N_{S}=3, N_{NER}=2, and N_{RE}=1. Joint model 1000 is then trained in the same manner as described in reference to FIG. 10A. In some instances, the loss achieved with the hyperparameters used in FIG. 10D may be compared to the losses achieved with the hyperparameters used in FIGS. 10A-10C to determine which set of values may be selected and used for the hyperparameters of joint model 1000 after completion of the training process. Alternatively or additionally, in some embodiments, each of joint models 1000 trained in FIGS. 10A-10D may be evaluated using an evaluation dataset to determine which set of values may be selected and used for the hyperparameters of joint model 1000.

In some embodiments, the training process may include dynamically modifying the values for hyperparameters 1058 to evaluate the training accuracy for each different set of hyperparameters. In some embodiments, the accuracy of the training using a particular set of hyperparameters may be referred to as a training result and/or a training accuracy. In some embodiments, the accuracy of the training may be inversely proportional to the calculcated loss. In the illustrated example, a first training result (or a first training accuracy) may be produced for the hyperparameters used in FIG. 10A, a second training result (or a second training accuracy) may be produced for the hyperparameters used in FIG. 10B, a third training result (or a third training accuracy) may be produced for the hyperparameters used in FIG. 10C, and a fourth training result (or a fourth training accuracy) may be produced for the hyperparameters used in FIG. 10D. The first, second, third, and fourth training results may be compared to each other to identify a maximum (or best) training result, and the corresponding hyperparameters may be selected and used for the hyperparameters of joint model 1000 after completion of the training process.

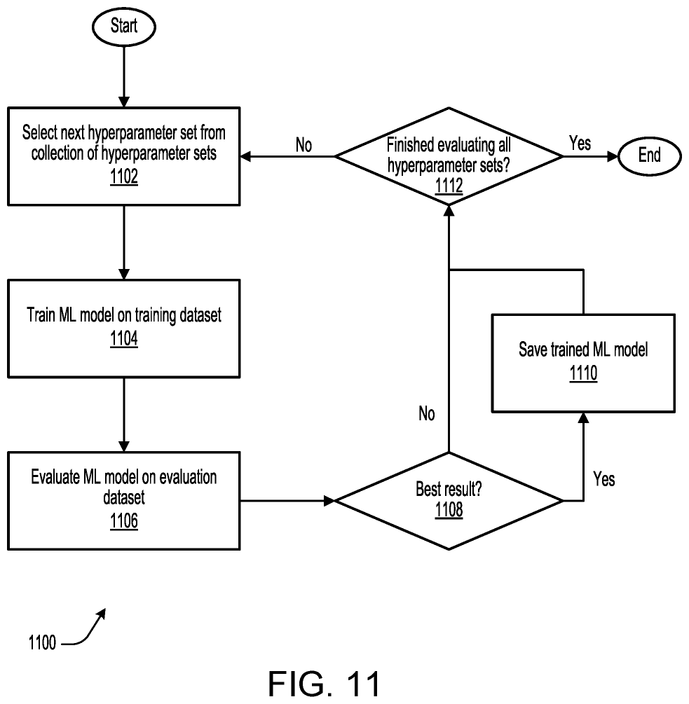

FIG. 11 illustrates a method 1100 of training an ML model (e.g., joint models 200, 300, 400, 1000) to jointly perform NER and RE on an input text (e.g., input text 150, 250, 1050). Alternatively or additionally, method 1100 may be considered to be a method of selecting a set of hyperparameters or a method of selecting a set of values for the set of hyperparameters. One or more steps of method 1100 may be omitted during performance of method 1100, and steps of method 1100 may be performed in any order and/or in parallel. One or more steps of method 1100 may be performed by one or more processors. Method 1100 may be implemented as a computer-readable medium or computer program product comprising instructions which, when the program is executed by one or more computers, cause the one or more computers to carry out the steps of method 1100.

At step 1102, a first (or next) hyperparameter set from a collection of hyperparameter sets is selected. Optionally, in some embodiments, step 1102 may include selecting a next set of values for the set of hyperparameters, the next set of values being one of the collection of hyperparameter sets.

At step 1104, the ML model having the selected hyperparameter set is trained on a training dataset. In some embodiments, a training result may be produced based on the training. Optionally, in some embodiments, step 1104 may include training the ML model having the selected set of values for the set of hyperparameters on the training dataset.

At step 1106, the trained ML model having the selected hyperparameter set is evaluated on an evaluation dataset to produce an evaluation result. Optionally, in some embodiments, step 1106 may include evaluating the trained ML model having the selected set of values for the set of hyperparameters on the evaluation dataset to produce an evaluation result.

At step 1108, it is determined whether the evaluation result is the best evaluation result (e.g., maximum or minimum) compared to previously produced evaluation results. If the evaluation result is the best evaluation result, then method 1100 proceeds to step 1110. Otherwise, method 1100 proceeds to step 1112. Optionally, in some embodiments, step 1108, may include determining whether the training result is the best training result (e.g., maximum or minimum) compared to previously produced training results.

At step 1110, the trained ML model having the selected hyperparameter set is saved and stored. Optionally, in some embodiments, step 1110 may include saving and storing the trained ML model having the selected set of values for the set of hyperparameters.

At step 1112, it is determined whether all hyperparameter sets from the collection of hyperparameter sets have been evaluated. If all hyperparameter sets have been evaluated, then method 1100 ends. Otherwise, method 1100 returns to step 1102. Optionally, in some embodiments, step 1110 may include determining whether all sets of values for the set of hyperparameters have been evaluated.

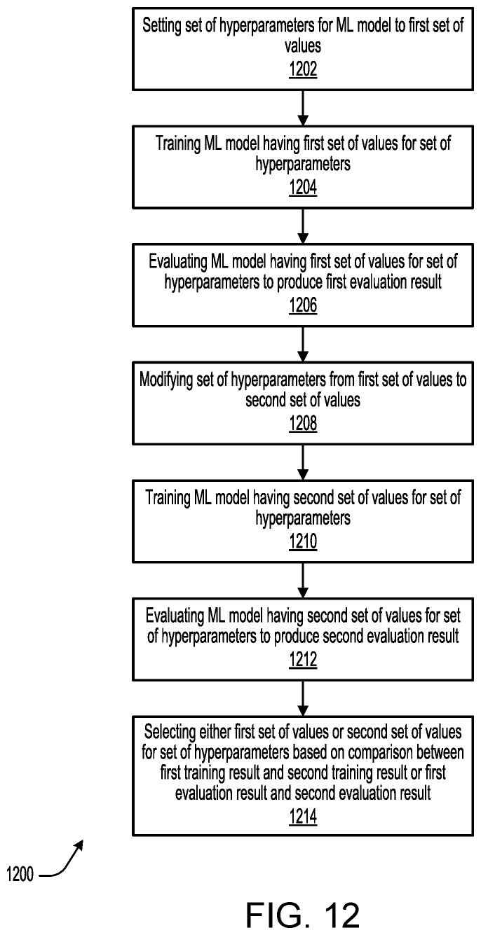

FIG. 12 illustrates a method 1200 of training a machine learning (ML) model (e.g., joint models 200, 300, 400, 1000) to jointly perform NER and RE on an input text (e.g., input text 150, 250, 1050). Alternatively or additionally, method 1200 may be considered to be a method of selecting a set of hyperparameters or a method of selecting a set of values for the set of hyperparameters. One or more steps of method 1200 may be omitted during performance of method 1200, and steps of method 1200 may be performed in any order and/or in parallel. One or more steps of method 1200 may be performed by one or more processors. Method 1200 may be implemented as a computer-readable medium or computer program product comprising instructions which, when the program is executed by one or more computers, cause the one or more computers to carry out the steps of method 1200.

At step 1202, a set of hyperparameters (e.g., hyperparameters 1058) for the ML model are set to a first set of values. The set of hyperparameters may include a quantity (e.g., N_{S}) of shared layers (e.g., shared layers 314, 414, 1014) in the ML model, a quantity (e.g., N_{NER}) of NER-specific layers (e.g., NER-specific layers 320, 420, 1020) in the ML model, and a quantity (e.g., N_{RE}) of RE-specific layers (e.g., RE-specific layers 322, 422, 1022) in the ML model. The shared layers precede each of the NER-specific layers and the RE-specific layers in the ML model.

At step 1204, the ML model having the first set of values for the set of hyperparameters is trained. The ML model having the first set of values for the set of hyperparameters may be trained using a training dataset. In some embodiments, a first training result may be produced based on training the ML model having the first set of values for the set of hyperparameters. The first training result may be a first training accuracy. The first training accuracy may be inversely proportional to a first loss (e.g., loss 1062) achieved while training the ML model having the first set of values for the set of hyperparameters. The first loss may be the sum of a first NER loss associated with the NER-specific layers and a first RE loss associated with the RE-specific layers.

At step 1206, the ML model having the first set of values for the set of hyperparameters is evaluated to produce a first evaluation result. The ML model having the first set of values for the set of hyperparameters may be evaluated using an evaluation dataset.

At step 1208, the set of hyperparameters are modified from the first set of values to a second set of values.

At step 1210, the ML model having the second set of values for the set of hyperparameters is trained. The ML model having the second set of values for the set of hyperparameters may be trained using the training dataset (e.g., a different training dataset or the same training dataset used in step 1204). In some embodiments, a second training result may be produced based on training the ML model having the second set of values for the set of hyperparameters. The second training result may be a second training accuracy. The second training accuracy may be inversely proportional to a second loss (e.g., loss 1062) achieved while training the ML model having the second set of values for the set of hyperparameters. The second loss may be the sum of a second NER loss associated with the NER-specific layers and a second RE loss associated with the RE-specific layers.

At step 1212, the ML model having the second set of values for the set of hyperparameters is evaluated to produce a second evaluation result. The ML model having the second set of values for the set of hyperparameters may be evaluated using the evaluation dataset (e.g., a different evaluation dataset or the same evaluation dataset used in step 1204).

At step 1214, either the first set of values or the second set of values are selected for the set of hyperparameters for the ML model based on a comparison between the first training result and the second training result or a comparison between the first evaluation result and the second evaluation result. The selected set of values may be used for the set of hyperparameters for the ML model and a corresponding set of trained weights may be used for a set of weights for the ML model.

In some embodiments, comparing the first training result and the second training result may include determining whether the first training accuracy is better than (e.g., greater than) the second training accuracy. If the first training accuracy is better than (e.g., greater than) the second training accuracy, the first set of values may be selected for the set of hyperparameters. If the second training accuracy is better than (e.g., greater than) the first training accuracy, the second set of values may be selected for the set of hyperparameters. In some embodiments, comparing the first evaluation result and the second evaluation result may include determining whether the first evaluation result is better than (e.g., greater than) the second evaluation result. If the first evaluation result is better than (e.g., greater than) the second evaluation result, the first set of values may be selected for the set of hyperparameters. If the second evaluation result is better than (e.g., greater than) the first evaluation result, the second set of values may be selected for the set of hyperparameters.

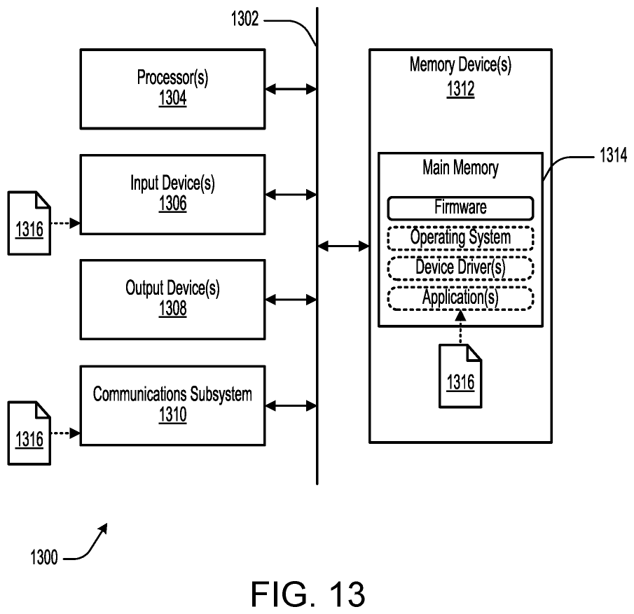

FIG. 13 illustrates an example computer system 1300 comprising various hardware elements, according to some embodiments of the present disclosure. Computer system 1300 may be incorporated into or integrated with devices described herein and/or may be configured to perform some or all of the steps of the methods provided by various embodiments. For example, in various embodiments, computer system 1300 may be configured to perform methods 1100 or 1200. It should be noted that FIG. 13 is meant only to provide a generalized illustration of various components, any or all of which may be utilized as appropriate. FIG. 13, therefore, broadly illustrates how individual system elements may be implemented in a relatively separated or relatively more integrated manner.

In the illustrated example, computer system 1300 includes a communication medium 1302, one or more processor(s) 1304, one or more input device(s) 1306, one or more output device(s) 1308, a communications subsystem 1310, and one or more memory device(s) 1312. Computer system 1300 may be implemented using various hardware implementations and embedded system technologies. For example, one or more elements of computer system 1300 may be implemented as a field-programmable gate array (FPGA), such as those commercially available by XILINX®, INTEL®, or LATTICE SEMICONDUCTOR®, a system-on-a-chip (SoC), an application-specific integrated circuit (ASIC), an application-specific standard product (ASSP), a microcontroller, and/or a hybrid device, such as an SoC FPGA, among other possibilities.

The various hardware elements of computer system 1300 may be coupled via communication medium 1302. While communication medium 1302 is illustrated as a single connection for purposes of clarity, it should be understood that communication medium 1302 may include various numbers and types of communication media for transferring data between hardware elements. For example, communication medium 1302 may include one or more wires (e.g., conductive traces, paths, or leads on a printed circuit board (PCB) or integrated circuit (IC), microstrips, striplines, coaxial cables), one or more optical waveguides (e.g., optical fibers, strip waveguides), and/or one or more wireless connections or links (e.g., infrared wireless communication, radio communication, microwave wireless communication), among other possibilities.

In some embodiments, communication medium 1302 may include one or more buses connecting pins of the hardware elements of computer system 1300. For example, communication medium 1302 may include a bus connecting processor(s) 1304 with main memory 1314, referred to as a system bus, and a bus connecting main memory 1314 with input device(s) 1306 or output device(s) 1308, referred to as an expansion bus. The system bus may consist of several elements, including an address bus, a data bus, and a control bus. The address bus may carry a memory address from processor(s) 1304 to the address bus circuitry associated with main memory 1314 in order for the data bus to access and carry the data contained at the memory address back to processor(s) 1304. The control bus may carry commands from processor(s) 1304 and return status signals from main memory 1314. Each bus may include multiple wires for carrying multiple bits of information and each bus may support serial or parallel transmission of data.

Processor(s) 1304 may include one or more central processing units (CPUs), graphics processing units (GPUs), neural network processors or accelerators, digital signal processors (DSPs), and/or the like. A CPU may take the form of a microprocessor, which is fabricated on a single IC chip of metal-oxide-semiconductor field-effect transistor (MOSFET) construction. Processor(s) 1304 may include one or more multi-core processors, in which each core may read and execute program instructions simultaneously with the other cores.

Input device(s) 1306 may include one or more of various user input devices such as a mouse, a keyboard, a microphone, as well as various sensor input devices, such as an image capture device, a pressure sensor (e.g., barometer, tactile sensor), a temperature sensor (e.g., thermometer, thermocouple, thermistor), a movement sensor (e.g., accelerometer, gyroscope, tilt sensor), a light sensor (e.g., photodiode, photodetector, charge-coupled device), and/or the like. Input device(s) 1306 may also include devices for reading and/or receiving removable storage devices or other removable media. Such removable media may include optical discs (e.g., Blu-ray discs, DVDs, CDs), memory cards (e.g., CompactFlash card, Secure Digital (SD) card, Memory Stick), floppy disks, Universal Serial Bus (USB) flash drives, external hard disk drives (HDDs) or solid-state drives (SSDs), and/or the like.

Output device(s) 1308 may include one or more of various devices that convert information into human-readable form, such as without limitation a display device, a speaker, a printer, and/or the like. Output device(s) 1308 may also include devices for writing to removable storage devices or other removable media, such as those described in reference to input device(s) 1306. Output device(s) 1308 may also include various actuators for causing physical movement of one or more components. Such actuators may be hydraulic, pneumatic, electric, and may be provided with control signals by computer system 1300.

Communications subsystem 1310 may include hardware components for connecting computer system 1300 to systems or devices that are located external computer system 1300, such as over a computer network. In various embodiments, communications subsystem 1310 may include a wired communication device coupled to one or more input/output ports (e.g., a universal asynchronous receiver-transmitter (UART)), an optical communication device (e.g., an optical modem), an infrared communication device, a radio communication device (e.g., a wireless network interface controller, a BLUETOOTH® device, an IEEE 802.11 device, a Wi-Fi device, a Wi-Max device, a cellular device), among other possibilities.

Memory device(s) 1312 may include the various data storage devices of computer system 1300. For example, memory device(s) 1312 may include various types of computer memory with various response times and capacities, from faster response times and lower capacity memory, such as processor registers and caches (e.g., L0, L1, L2), to medium response time and medium capacity memory, such as random access memory, to lower response times and lower capacity memory, such as solid state drives and hard drive disks. While processor(s) 1304 and memory device(s) 1312 are illustrated as being separate elements, it should be understood that processor(s) 1304 may include varying levels of on-processor memory, such as processor registers and caches that may be utilized by a single processor or shared between multiple processors.

Memory device(s) 1312 may include main memory 1314, which may be directly accessible by processor(s) 1304 via the memory bus of communication medium 1302. For example, processor(s) 1304 may continuously read and execute instructions stored in main memory 1314. As such, various software elements may be loaded into main memory 1314 to be read and executed by processor(s) 1304 as illustrated in FIG. 13. Typically, main memory 1314 is volatile memory, which loses all data when power is turned off and accordingly needs power to preserve stored data. Main memory 1314 may further include a small portion of non-volatile memory containing software (e.g., firmware, such as BIOS) that is used for reading other software stored in memory device(s) 1312 into main memory 1314. In some embodiments, the volatile memory of main memory 1314 is implemented as random-access memory (RAM), such as dynamic RAM (DRAM), and the non-volatile memory of main memory 1314 is implemented as read-only memory (ROM), such as flash memory, erasable programmable read-only memory (EPROM), or electrically erasable programmable read-only memory (EEPROM).

Computer system 1300 may include software elements, shown as being currently located within main memory 1314, which may include an operating system, device driver(s), firmware, compilers, and/or other code, such as one or more application programs, which may include computer programs provided by various embodiments of the present disclosure. Merely by way of example, one or more steps described with respect to any methods discussed above, might be implemented as instructions 1316, executable by computer system 1300. In one example, such instructions 1316 may be received by computer system 1300 using communications subsystem 1310 (e.g., via a wireless or wired signal carrying instructions 1316), carried by communication medium 1302 to memory device(s) 1312, stored within memory device(s) 1312, read into main memory 1314, and executed by processor(s) 1304 to perform one or more steps of the described methods. In another example, instructions 1316 may be received by computer system 1300 using input device(s) 1306 (e.g., via a reader for removable media), carried by communication medium 1302 to memory device(s) 1312, stored within memory device(s) 1312, read into main memory 1314, and executed by processor(s) 1304 to perform one or more steps of the described methods.

In some embodiments of the present disclosure, instructions 1316 are stored on a computer-readable storage medium, or simply computer-readable medium. Such a computer-readable medium may be non-transitory, and may therefore be referred to as a non-transitory computer-readable medium. In some cases, the non-transitory computer-readable medium may be incorporated within computer system 1300. For example, the non-transitory computer-readable medium may be one of memory device(s) 1312, as shown in FIG. 13, with instructions 1316 being stored within memory device(s) 1312. In some cases, the non-transitory computer-readable medium may be separate from computer system 1300. In one example, the non-transitory computer-readable medium may be a removable media provided to input device(s) 1306, such as those described in reference to input device(s) 1306, as shown in FIG. 13, with instructions 1316 being provided to input device(s) 1306. In another example, the non-transitory computer-readable medium may be a component of a remote electronic device, such as a mobile phone, that may wirelessly transmit a data signal carrying instructions 1316 to computer system 1300 using communications subsystem 1316, as shown in FIG. 13, with instructions 1316 being provided to communications subsystem 1310.

Instructions 1316 may take any suitable form to be read and/or executed by computer system 1300. For example, instructions 1316 may be source code (written in a human-readable programming language such as Java, C, C++, C#, Python), object code, assembly language, machine code, microcode, executable code, and/or the like. In one example, instructions 1316 are provided to computer system 1300 in the form of source code, and a compiler is used to translate instructions 1316 from source code to machine code, which may then be read into main memory 1314 for execution by processor(s) 1304. As another example, instructions 1316 are provided to computer system 1300 in the form of an executable file with machine code that may immediately be read into main memory 1314 for execution by processor(s) 1304. In various examples, instructions 1316 may be provided to computer system 1300 in encrypted or unencrypted form, compressed or uncompressed form, as an installation package or an initialization for a broader software deployment, among other possibilities.

In one aspect of the present disclosure, a system (e.g., computer system 1300) is provided to perform methods in accordance with various embodiments of the present disclosure. For example, some embodiments may include a system comprising one or more processors (e.g., processor(s) 1304) that are communicatively coupled to a non-transitory computer-readable medium (e.g., memory device(s) 1312 or main memory 1314). The non-transitory computer-readable medium may have instructions (e.g., instructions 1316) stored therein that, when executed by the one or more processors, cause the one or more processors to perform the methods described in the various embodiments.

In another aspect of the present disclosure, a computer-program product that includes instructions (e.g., instructions 1316) is provided to perform methods in accordance with various embodiments of the present disclosure. The computer-program product may be tangibly embodied in a non-transitory computer-readable medium (e.g., memory device(s) 1312 or main memory 1314). The instructions may be configured to cause one or more processors (e.g., processor(s) 1304) to perform the methods described in the various embodiments.

In another aspect of the present disclosure, a non-transitory computer-readable medium (e.g., memory device(s) 1312 or main memory 1314) is provided. The non-transitory computer-readable medium may have instructions (e.g., instructions 1316) stored therein that, when executed by one or more processors (e.g., processor(s) 1304), cause the one or more processors to perform the methods described in the various embodiments.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

As used herein and in the appended claims, the singular forms “a”, “an”, and “the” include plural references unless the context clearly dictates otherwise. Thus, for example, reference to “a user” includes reference to one or more of such users, and reference to “a processor” includes reference to one or more processors and equivalents thereof known to those skilled in the art, and so forth.

Also, the words “comprise,” “comprising,” “contains,” “containing,” “include,” “including,” and “includes,” when used in this specification and in the following claims, are intended to specify the presence of stated features, integers, components, or steps, but they do not preclude the presence or addition of one or more other features, integers, components, steps, acts, or groups.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method of training a machine learning (ML) model to jointly perform named entity recognition (NER) and relation extraction (RE) on an input text, the method comprising:
setting a set of hyperparameters for the ML model to a first set of values, the set of hyperparameters including a quantity of shared layers in the ML model, a quantity of NER-specific layers in the ML model, and a quantity of RE-specific layers in the ML model, wherein the shared layers precede each of the NER-specific layers and the RE-specific layers in the ML model;
training the ML model having the first set of values for the set of hyperparameters using a training dataset;
evaluating the ML model having the first set of values for the set of hyperparameters using an evaluation dataset to produce a first evaluation result;
modifying the set of hyperparameters from the first set of values to a second set of values;
training the ML model having the second set of values for the set of hyperparameters using the training dataset;
evaluating the ML model having the second set of values for the set of hyperparameters using the evaluation dataset to produce a second evaluation result; and
selecting either the first set of values or the second set of values for the set of hyperparameters for the ML model based on a comparison between the first evaluation result and the second evaluation result.

2. The method of claim 1, wherein the ML model is a neural network.

3. The method of claim 1, wherein an output of the NER-specific layers is provided to an intermediate layer of the RE-specific layers.

4. The method of claim 1, wherein the ML model having the first set of values for the set of hyperparameters and the ML model having the second set of values for the set of hyperparameters are evaluated using an evaluation dataset.

5. The method of claim 1, wherein the shared layers include one or more shared bidirectional recurrent neural network (BiRNN) layers, and wherein the quantity of the shared layers corresponds to a quantity of the shared BiRNN layers.

6. The method of claim 1, wherein the NER-specific layers include one or more NER-specific bidirectional recurrent neural network (BiRNN) layers, and wherein the quantity of the NER-specific layers corresponds to a quantity of the NER-specific BiRNN layers.

7. The method of claim 1, wherein the RE-specific layers include one or more RE-specific bidirectional recurrent neural network (BiRNN) layers, and wherein the quantity of the RE-specific layers corresponds to a quantity of the RE-specific BiRNN layers.

8. A non-transitory computer-readable medium comprising instructions that, when executed by one or more processors, cause the one or more processors to perform operations comprising:
setting a set of hyperparameters for a machine learning (ML) model to a first set of values, the set of hyperparameters including a quantity of shared layers in the ML model, a quantity of named entity recognition (NER)-specific layers in the ML model, and a quantity of relation extraction (RE)-specific layers in the ML model, wherein the shared layers precede each of the NER-specific layers and the RE-specific layers in the ML model;
training the ML model having the first set of values for the set of hyperparameters using a training dataset;
evaluating the ML model having the first set of values for the set of hyperparameters using an evaluation dataset to produce a first evaluation result;
modifying the set of hyperparameters from the first set of values to a second set of values;
training the ML model having the second set of values for the set of hyperparameters using the training dataset;
evaluating the ML model having the second set of values for the set of hyperparameters using the evaluation dataset to produce a second evaluation result; and
selecting either the first set of values or the second set of values for the set of hyperparameters for the ML model based on a comparison between the first evaluation result and the second evaluation result.

9. The non-transitory computer-readable medium of claim 8, wherein the ML model is a neural network.

10. The non-transitory computer-readable medium of claim 8, wherein an output of the NER-specific layers is provided to an intermediate layer of the RE-specific layers.

11. The non-transitory computer-readable medium of claim 8, wherein the ML model having the first set of values for the set of hyperparameters and the ML model having the second set of values for the set of hyperparameters are evaluated using an evaluation dataset.

12. The non-transitory computer-readable medium of claim 8, wherein the shared layers include one or more shared bidirectional recurrent neural network (BiRNN) layers, and wherein the quantity of the shared layers corresponds to a quantity of the shared BiRNN layers.

13. The non-transitory computer-readable medium of claim 8, wherein the NER-specific layers include one or more NER-specific bidirectional recurrent neural network (BiRNN) layers, and wherein the quantity of the NER-specific layers corresponds to a quantity of the NER-specific BiRNN layers.

14. The non-transitory computer-readable medium of claim 8, wherein the RE-specific layers include one or more RE-specific bidirectional recurrent neural network (BiRNN) layers, and wherein the quantity of the RE-specific layers corresponds to a quantity of the RE-specific BiRNN layers.

15. A system for training a machine learning (ML) model to jointly perform named entity recognition (NER) and relation extraction (RE) on an input text, the system comprising:
one or more processors; and
a computer-readable medium comprising instructions that, when executed by the one or more processors, cause the one or more processors to perform operations comprising:
setting a set of hyperparameters for the ML model to a first set of values, the set of hyperparameters including a quantity of shared layers in the ML model, a quantity of NER-specific layers in the ML model, and a quantity of RE-specific layers in the ML model, wherein the shared layers precede each of the NER-specific layers and the RE-specific layers in the ML model;
training the ML model having the first set of values for the set of hyperparameters using a training dataset;
evaluating the ML model having the first set of values for the set of hyperparameters using an evaluation dataset to produce a first evaluation result;
modifying the set of hyperparameters from the first set of values to a second set of values;
training the ML model having the second set of values for the set of hyperparameters using the training dataset;
evaluating the ML model having the second set of values for the set of hyperparameters using the evaluation dataset to produce a second evaluation result; and
selecting either the first set of values or the second set of values for the set of hyperparameters for the ML model based on a comparison between the first evaluation result and the second evaluation result.

16. The system of claim 15, wherein the ML model is a neural network.

17. The system of claim 15, wherein an output of the NER-specific layers is provided to an intermediate layer of the RE-specific layers.

18. The system of claim 15, wherein the ML model having the first set of values for the set of hyperparameters and the ML model having the second set of values for the set of hyperparameters are evaluated using an evaluation dataset.

19. The system of claim 15, wherein the shared layers include one or more shared bidirectional recurrent neural network (BiRNN) layers, and wherein the quantity of the shared layers corresponds to a quantity of the shared BiRNN layers.

20. The system of claim 15, wherein the NER-specific layers include one or more NER-specific bidirectional recurrent neural network (BiRNN) layers, and wherein the quantity of the NER-specific layers corresponds to a quantity of the NER-specific BiRNN layers.
